(19) United States
(12) Patent Application Publication
(10) Pub. No.: US 2008/0062173 A1
(43) Pub. Date: Mar. 13, 2008

(54) Method and apparatus for selecting absolute location on three-dimensional image on navigation display

(76) Inventor: Eric Tashiro, Torrance, CA (US)

Correspondence Address: MURAMATSU & ASSOCIATES, Suite 310, 114 Pacifica, Irvine, CA, 92618, US

(21) Appl. No.: 11/520,291

(22) Filed: Sep. 13, 2006

(51) Int. Cl. G06T 15/20

(52) U.S. Cl. 345/427

(57) ABSTRACT

A method and apparatus for a navigation system for selecting a location on a three-dimensional map view has a pyramid cursor that identifies a focused location and a means to change a viewing angle. The three-dimensional map view shows the three-dimensional image of roads and flat surfaces but not buildings or other structures erected on the surfaces. The three-dimensional image of the building and other structure only within the area of the pyramid icon will be displayed on the screen. The navigation system allows the user to change the viewing angle of the three-dimensional view up to a top view so that a user can select a particular location on the top view.

### FIELD OF THE INVENTION

This invention relates generally to a method and apparatus for selecting an absolute location on a three-dimensional image, and more particularly, to a method and apparatus for selecting an absolute location on a three-dimensional image by selecting an area to be focused and rotating the three-dimensional view up to a two dimensional view showing a top view of the selected area.

### BACKGROUND OF THE INVENTION

A navigation system performs travel guidance for enabling a user to easily and quickly reach the selected destination. A typical example is a vehicle navigation system where a vehicle is equipped with a navigation function to guide a driver to a destination through a calculated route. Such a navigation system detects the position of the user's vehicle, and reads out map data pertaining to an area at the current vehicle position from a data storage medium. Typically, the navigation system displays a map image on a monitor screen while superimposing thereon a mark representing the current location of the user.

FIGS. 1A-1H show an example of overall procedure and screen display involved in the navigation system for route guidance to a destination. FIG. 1A shows an example of map screen of the navigation system when the destination is not specified. Typically, the navigation system displays a street on which the vehicle (vehicle position VP) is running on a map image and a name of the street. Other information such as a north pointer NP, a map scale and a current time may also be illustrated on the display screen.

An example of process for specifying a destination in the navigation system is shown in FIG. 1B-1F. A main menu screen such as shown in FIG. 1B displays menu items including a “Destination” menu for entering the destination. When selecting “Destination”, the navigation system displays a “Find Destination by” screen as shown in FIG. 1C for specifying an input method for selecting the destination. The “Find Destination By” screen lists various methods for selecting the destination such as “Address”, “Intersection”, and “Point of Interest (POI)”, “Map Cursor”, etc. each of which is known in the art.

When selecting, the “Point of Interest” method in FIG. 1C, the navigation system displays selection methods of point of interest (POI) either by “Place Name” or “Place Type” in FIG. 1D. If the “Place Type” is selected in FIG. 1D, the navigation system lists categories of POIs as shown in FIG. 1E. FIG. 1F shows a screen when the user has selected a “Fast Foods” category. In FIG. 1G, the navigation system displays a progress scale during the calculation of the route to the destination. After determining the guided route, the navigation system starts the route guidance as shown in FIG. 1H. Typically, the navigation system shows the intersection that is highlighted to show the next turn and a direction of the turn.

FIG. 2 is schematic diagram showing a two-dimensional view of map image on a screen of the navigation system. The map image can be used in various ways, for example, it may be used to determine the current position by checking the current position indicator on the map, or it can also be used to select a particular location on the map by pointing a cursor. For example, by clicking the cursor on the map, the user may instruct the navigation system to find a route to the selected location and guide the user to the location. In the example of FIG. 2, the navigation screen 79 includes a two-dimensional map image 73, a cursor 62, and a back key 71 for moving back to the previous display.

FIG. 3 is a schematic diagram showing an example of three-dimensional view of the map image on the navigation screen. Three-dimensional view is advantageous in providing the user a better visibility similar to an actual view, especially of buildings and other structures. Although the three-dimensional view has the advantage as described above, to illustrate all of the buildings and other structures, it requires a large amount of resources of the navigation system such as a high computer power, a long calculation time, a large memory space, etc.

Another shortcoming of the three-dimensional map image resides in that it is difficult to pinpoint a location on the map image. For example, a location of a point of interest (POI) may be hidden behind a building in the three-dimensional view. Even if the location is not hidden behind a building, it is difficult to point a location on a three dimensional map when, for example, an intended location is within a multistory building. Thus, there is a need of a new method and apparatus for a navigation system to easily locate a spot on a map image while taking advantage of the three-dimensional map view.

### SUMMARY OF THE INVENTION

It is, therefore, an object of the present invention to provide a method and apparatus for a navigation system to select an absolute location on a three-dimensional image on the navigation system screen.

It is another object of the present invention to provide a method and apparatus for a navigation system to freely change an viewing angle of the three-dimensional map image on the navigation system screen so that the map image can be continuously changed between the three-dimensional view and the two dimensional view.

It is a further object of the present invention to provide a method and apparatus for a navigation system to easily select an area for displaying a three-dimensional image of buildings and other structures within the selected area and change a viewing angle of the three-dimensional image of the buildings and other structures within the selected area.

One aspect of the present invention is a display method for a navigation system. The method includes the following steps of displaying a three-dimensional map view on a screen which shows three-dimensional images of roads and ground surfaces but not that of buildings or other structures erected on the surfaces, moving a three-dimensional cursor on the three-dimensional image for specifying an area for displaying three-dimensional images of buildings and other structures within the specified area, changing a viewing angle of the three-dimensional images of buildings and other structures within the specified area until the screen shows a top view of the specified area, and selecting a location on the top view by pointing a cursor thereto.

In the display method, the process of displaying the three-dimensional map view includes a process of displaying the three-dimensional cursor for specifying the area on the map view, a scroll key for changing the viewing angle of the three-dimensional view within the specified area, and an angle indicator which changes in response to movements of the scroll key.

In the display method, the process of changing the viewing angle of the three-dimensional map view includes a process of displaying a two-dimensional view of the specified area which corresponds to said top view of the specified area when the viewing angle is set to one extreme, and a process of displaying a two-dimensional view of the specified area which corresponds to a front view of the specified area when the viewing angle is set to another extreme.

Another aspect of the present invention is an apparatus for selecting an absolute location on the three-dimensional image by selecting an area to be focused and rotating the three-dimensional view up to a two dimensional view showing the top view of the selected area. The apparatus of the present invention is configured to implement the steps defined in the method noted above.

According to the method and apparatus of the present invention, the three-dimensional view of the selected area is rotated about a horizontal axis by changing its viewing angle until it becomes a two-dimensional view which is a top view of the selected area so that the user can select an absolute location on the map image such as a location of the points of interest (POIs) can be displayed. The method uses the three dimensional cursor that covers the specified area on the three-dimensional map image for displaying the detailed three-dimensional view of the specified area. The detailed three-dimensional view of structures such as buildings are displayed only for the specified area. By changing the location of the three-dimensional cursor on the map image, any desired location can be specified by the user. The user can easily change the viewing angle of the three-dimensional view of the specified area and select an absolute location therein when the three-dimensional view is changed to the top view of the specified area.

### BRIEF DESCRIPTION OF THE DRAWINGS

FIGS. 1A-1H are schematic diagrams showing an example of operational process and screen display involved in the navigation system for selecting a destination and driving to the selected destination.

FIG. 2 is a schematic diagram showing an example of two-dimensional map image and a current vehicle position thereon in a conventional navigation system.

FIG. 3 is a schematic diagram showing an example of a three-dimensional image of roads and buildings on a screen of the navigation system.

FIGS. 4A and 4B are schematic diagrams showing examples of screen display in accordance with the present invention where FIG. 4A is a three-dimensional map view showing a pyramid cursor for selecting an area and an angle scroll mechanism for changing a viewing angle of the three-dimensional image within the selected area, and FIG. 4B is a three-dimensional map view showing an enlarged image of the buildings within the selected area and the viewing angle specified in FIG. 4A.

FIGS. 5A and 5B are schematic diagrams showing examples of screen display in accordance with the present invention where FIG. 5A is a three-dimensional map view with the viewing angle selected by the scroll arrow and FIG. 5B is a top view of the area selected by the pyramid cursor shown in FIG. 4A attained by changing the three-dimensional view to an extreme so that the navigation screen shows a two-dimensional view.

FIGS. 6A and 6B are schematic views showing the relationship among an angle indicator, a scroll arrow and a resultant three-dimensional map view under the present invention where the viewing angle is about 60 degrees.

FIGS. 7A and 7B are schematic views showing the relationship among the angle indicator, the scroll arrow and the resultant three-dimensional map view under the present invention where the viewing angle is changed to an extreme of 0 degree so that the navigation system shows a front view of the buildings.

FIGS. 8A and 8B are schematic views showing the relationship among the angle indicator, the scroll arrow and the resultant three-dimensional map view under the present invention where the viewing angle is changed to another extreme of 90 degrees so that the navigation system shows a top view of the buildings.

FIGS. 9A and 9B are schematic views showing alternative examples of the angle indicator and the scroll arrow under the present invention.

FIG. 10 is a flow chart showing an example of the operational steps for changing a viewing angle and selecting an absolute location on the three-dimensional map image under the present invention.

FIG. 11 is a block diagram showing an example of configuration of a vehicle navigation system implementing the present invention.

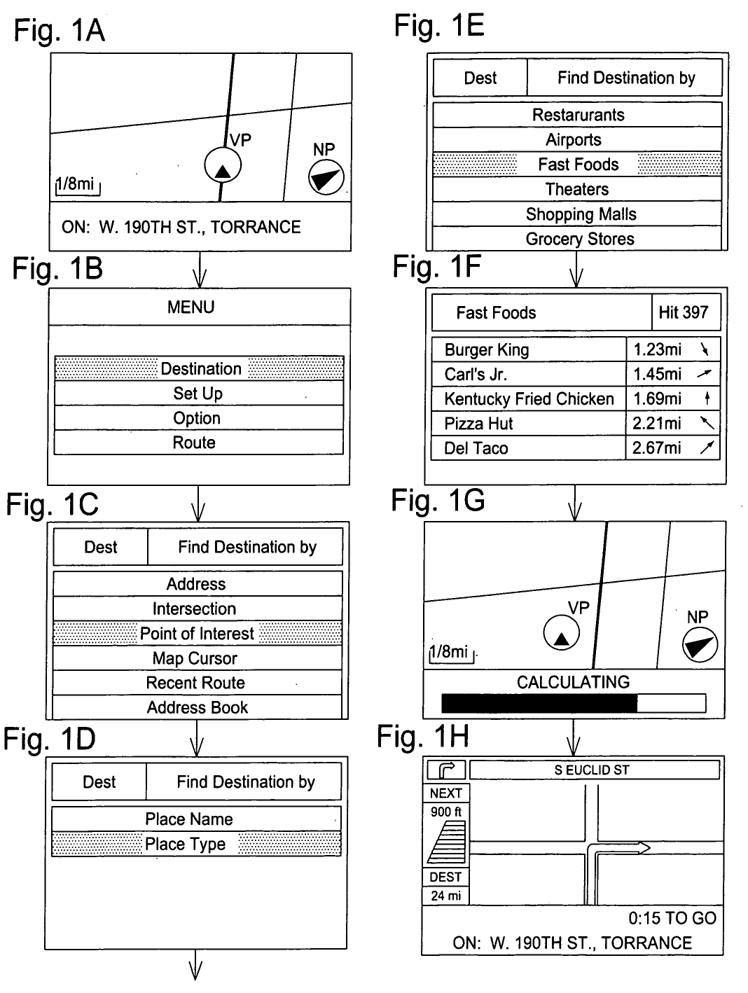

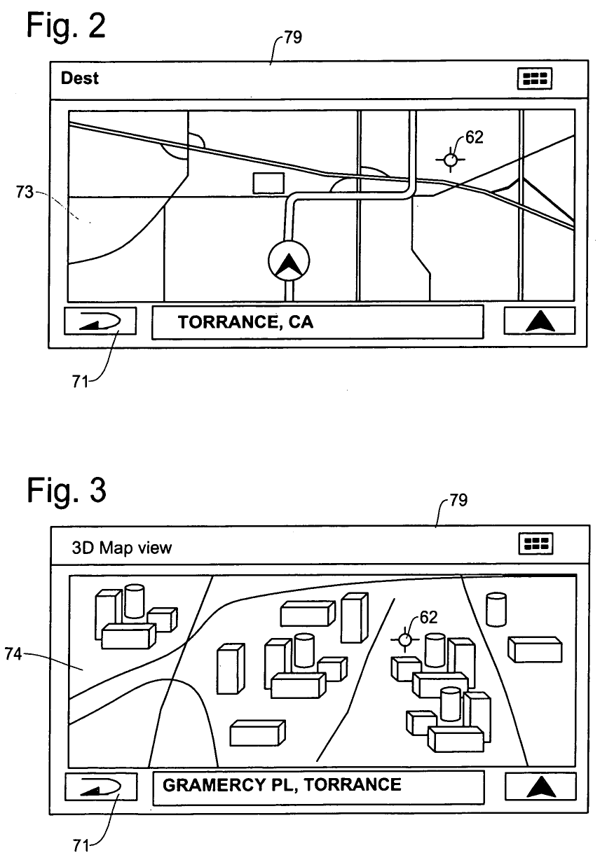

### DETAILED DESCRIPTION OF THE PREFERRED EMBODIMENT

The present invention will be described in detail with reference to the accompanying drawings. The method and apparatus of the present invention for displaying a three-dimensional map view of selected area overcomes the drawbacks described above and provides an easy and intuitive method to select an absolute location on the map. The three-dimensional view of the selected area is rotated about a horizontal axis by changing its viewing angle between two extremes (two-dimensional views) so that more precise location on the selected area such as a location of the points of interest (POIs) can be displayed.

The method uses a three dimensional cursor that covers a specified location of the three-dimensional map image for displaying a detailed three-dimensional view of the specified location. Namely, as noted above, because of the limited resources, the detailed three-dimensional view of structures such as buildings are displayed only for the specified location. By changing the location of the three-dimensional cursor on the map image, any desired location can be specified by the user.

In the screen of the navigation system, an angle indicator showing a viewing angle of a three-dimensional view and a means to change the viewing angle of the three-dimensional view are provided. The user can easily change the viewing angle of the three-dimensional view of the specified area. Thus, the user can continuously see among a front view (two-dimensional view), three-dimensional views with various viewing angles, and a top view (two-dimensional view) of the buildings and other structures in the selected area on the map image.

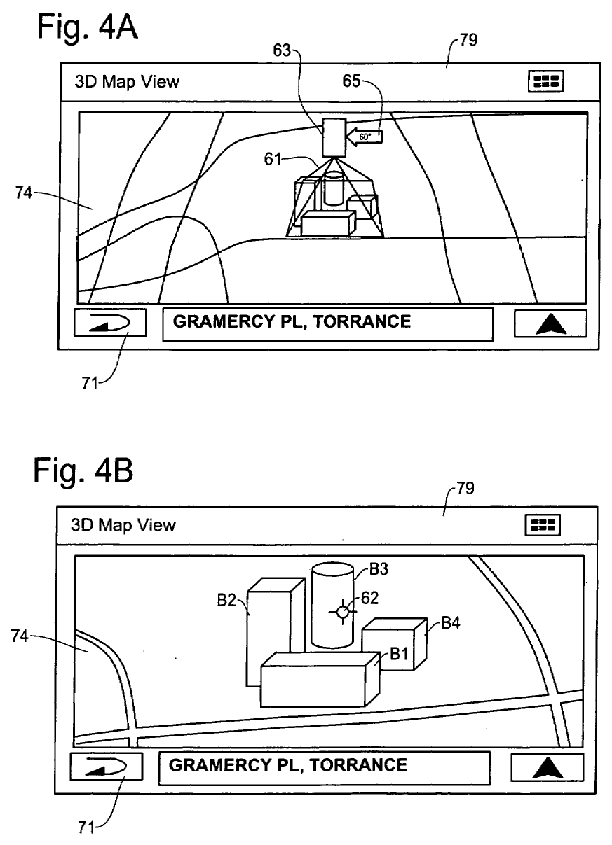

FIGS. 4A and 4B are schematic diagrams showing examples of screen display in accordance with the present invention. FIG. 4A is a three-dimensional map view showing a pyramid cursor (three-dimensional cursor) for selecting an area and an angle scroll mechanism for changing a viewing angle of three-dimensional image within the selected area. FIG. 4B is a three-dimensional map view showing an enlarged view of the building within the area specified by the pyramid cursor 61 and the viewing angle selected in FIG. 4A.

In this example, the display of FIG. 4A shows a three-dimensional view of the roads throughout the screen. However, to overcome the shortcomings of the conventional three dimensional map view while retaining the advantage thereof, it shows a three-dimensional view of the buildings and other structures only within the area specified by the pyramid cursor (three-dimensional cursor) 61. The pyramid cursor 61 can be freely moved by the user throughout the screen. The pyramid cursor 61 is used to focus an area on the three-dimensional map view so that three-dimensional images of buildings and other objects within the pyramid cursor 61 will be illustrated as shown in FIGS. 4A and 4B.

As noted above, the pyramid cursor 61 has a shape of a pyramid which may be appropriate to select an area to display in a three-dimensional fashion because it has a shape that is similar to a bird's eye view. Although the pyramid shape is used as the cursor 61 that specifies an area, other shapes may be used as well, such as a cylindrical shape or a conical shape for the same purpose. The pyramid cursor 61 may be moved around on the display by, for example, using a drag operation that is familiar in operating a personal computer, pressing arrow keys, or operating a joystick, etc. In FIG. 4A, at the top of the pyramid cursor 61, an angle indicator 63 and a scroll arrow (scroll key) 65 are shown.

The scroll arrow (scroll key) 65 is used to change a viewing angle of the three-dimensional image of the buildings and other structures within the area selected by the pyramid cursor 61. The angle indicator 63 is used to indicate an image of angle change of an object in response to the movement of the scroll arrow 65. For example, the angle indicator 63 can be a simplified top view of a polygonal box that rotates about an X-axis to provide the user with a feeling of angle change when the scroll arrow 65 is moved. Thus, the shape and size of the angle indicator 63 are unrelated to a particular shape or size of the buildings within the pyramid cursor 61.

When the user selects a viewing angle by operating the scroll arrow 65, the navigation system typically displays an enlarged three-dimensional view of the area selected by the pyramid cursor 61 as shown in FIG. 4B. Such a three-dimensional view provides a better visibility of the selected area because it shows an image similar to an actual view of the selected area. However, it is difficult for the user to pinpoint a particular location or to find a location of a particular point of interest on the three-dimensional view of FIG. 4B with use of a cursor 62.

The method and apparatus of three-dimensional display under the present invention can be used in various ways to accommodate the computation power of the navigation system. For example, the navigation system may show three-dimensional images of buildings and other structures in the area covered by the pyramid cursor 61 whereas it shows merely a perspective view of the roads and other flat objects to save computer power that would be expended if three-dimensional images of all buildings were to be displayed on the screen. Similarly, the navigation system may show three-dimensional images of buildings and other structures with colors and texture within the area covered by the pyramid cursor 61 whereas other areas show merely a perspective view of the roads and other flat objects.

When the user moves the scroll arrow 65 by dragging the arrow either upward or downward, the navigation system rotates the three-dimensional view specified by the pyramid cursor 61 about an X-axis (horizontal axis). In other words, the navigation system changes the viewing angle of the three-dimensional image. Therefore, the user can continuously see three-dimensional views with the desired viewing angles between the two extremes of the viewing angle where two-dimensional views (front view and top view) of a particular object such as a building within the pyramid cursor 61 are displayed.

As a consequence, the user is able to see the three-dimensional image of the buildings B1-B4 and other structures similar to an actual view. The user can freely select an area on the map image to see the three-dimensional image of the buildings by moving the pyramid cursor 61. When finding or selecting a particular location of, for example, a point of interest (POI) on the map image, the user can change the viewing angle of the three-dimensional view by controlling an scroll arrow 65 to reach the two-dimensional view (top view). Thus, it is possible to easily and accurately find an absolute location of the POI on the top view of the map image. This arrangement eliminates the drawback associated with a three-dimensional map view where a desired spot is hidden behind a building or other structures.

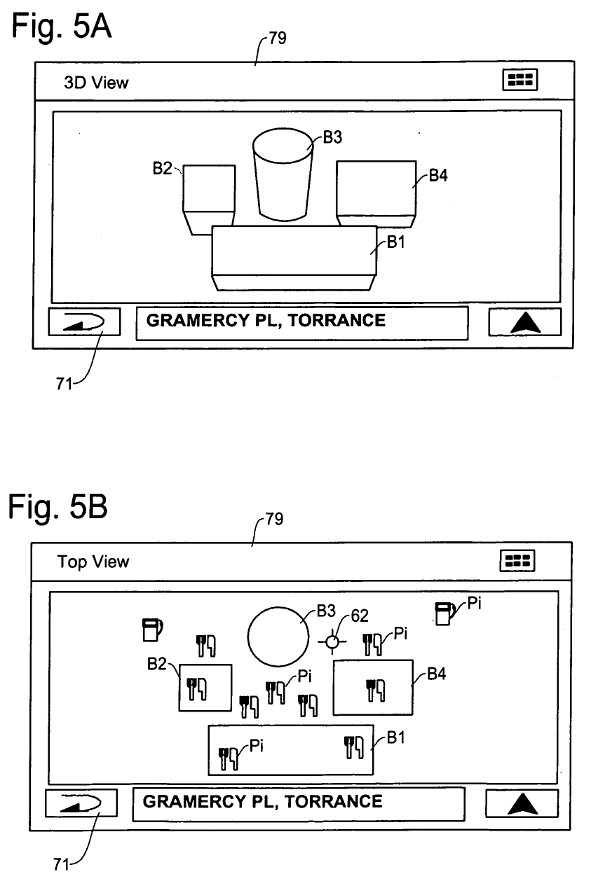

Thus, by changing the viewing angle by operating the scroll arrow 65 of FIG. 4A, the user can see the three-dimensional views with different viewing angle up to the top view (two-dimensional view) as shown in FIGS. 5A and 5B. Namely, FIGS. 5A and 5B are schematic diagrams showing examples of screen display in accordance with the present invention. FIG. 5A is a three-dimensional map view with the viewing angle selected by the scroll arrow 65. FIG. 5B is a top view of the area selected by the pyramid cursor shown in FIG. 4A attained by changing the three-dimensional view to an extreme so that the navigation screen shows the two-dimensional view.

In the example of FIG. 5A, the three-dimensional map view shows the three-dimensional structures of the buildings B1-B4 within the area specified by the pyramid cursor 61. The user can see the three-dimensional map view with the viewing angle selected by the scroll arrow 65. As noted above, it is difficult for the user to accurately specify a particular location on the three-dimensional view of FIG. 5A with use of a cursor 62 on the screen or to find a location of a particular point of interest based on, for example, locations of POI icons on the three-dimensional view of the selected area including the buildings B1-B4.

Therefore, the user changes the viewing angle of the three-dimensional view up to the extreme so that the navigation system now shows the two-dimensional view of the selected area including the buildings B1-B4 as shown in FIG. 5B. Since the two-dimensional view of FIG. 5B shows a top view of the area selected by the pyramid cursor 61, the user can specify a more accurate position on the screen by pointing the cursor 62. Further, since POI icons Pi can be displayed on accurate locations on the two-dimensional view, the user can select a POI icon such as a one behind the building by operating the cursor 62.

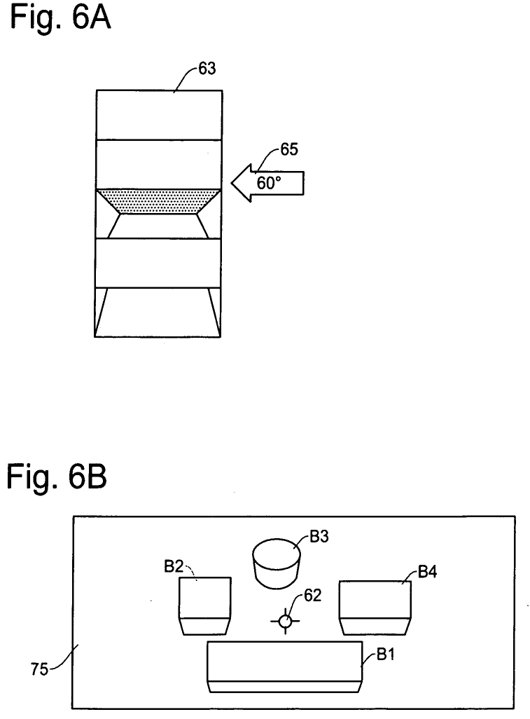

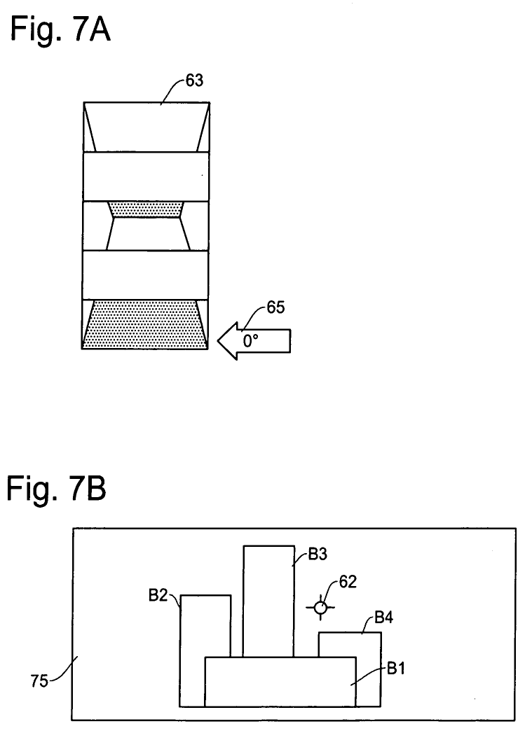

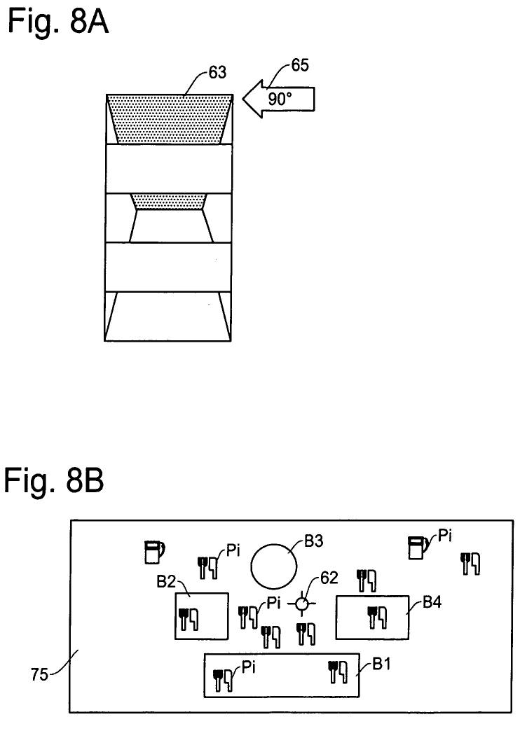

The relationship among the scroll arrow 65, the angle indicator 63 and the resultant top view display 75 is explained with reference to FIGS. 6A-6B, 7A-7B and 8A-8B. FIGS. 6A and 6B show the situation where the viewing angle is about 60 degrees, FIGS. 7A and 7B show the situation where the viewing angle is changed to an extreme of about 0 degree so that the navigation system shows a front view of the buildings within the selected area, and FIGS. 8A and 8B show the situation where the viewing angle is changed to another extreme of about 90 degrees so that the navigation system shows a top view of the selected area including the buildings B1-B4.

As described above, the user is able to change the viewing angle of the three-dimensional view within the area specified by the pyramid cursor 61 by scrolling the scroll arrow 65. In the example shown in FIGS. 6A-8B, the viewing angle can be continuously changed between 0° and 90° by operating the scroll arrow 65 on the screen. When the viewing angle is changed to one extreme, i.e., 0°, the three-dimensional view is changed to show a front view of the buildings B1-B4, i.e., a two-dimensional view as shown in FIG. 7B. When the viewing angle is changed to another extreme, i.e., 90°, the three-dimensional view is changed to show a top view of the buildings B1-B4, i.e., a two-dimensional view as shown in FIGS. 5B and 8B.

FIG. 6A shows the condition of the scroll arrow 65 and the angle indicator 63 where the viewing angle is set to 60 degrees. In this example, the angle is indicated numerically in the scroll arrow 65 and graphic representation of the angle is indicated in the angle indicator 63. As noted above, the angle indicator 63 is designed to give the user an impression that the angle is changing in response to the scroll arrow 65. Thus, for example, the angle indicator 63 changes in the manner similar to the rotation of a polygonal drum to reflect the change of the viewing angle by the scroll arrow 65. When the user selects the viewing angle of 60 degrees as shown in FIG. 6A, the navigation system displays the three-dimensional view as shown in FIG. 6B which shows the buildings B1-B4 viewed with 60 degrees relative to the horizontal surface.

FIG. 7A shows the condition of the scroll arrow 65 and the angle indicator 63 where the viewing angle is set to about 0 degree. In this example, the angle is indicated numerically in the scroll arrow 65 and graphic representation of the angle is indicated in the angle indicator 63. The angle indicator 63 changes in the manner similar to the rotation of the polygonal drum to reflect the change of the viewing angle by the scroll arrow 65. Since the viewing angle is set to 0 degree in FIG. 7A, the navigation system displays the two-dimensional view which is a front view of the buildings B1-B4 as shown in FIG. 7B because it shows the buildings B1-B4 viewed with 0 degree relative to the horizontal surface.

FIG. 8A shows the condition of the scroll arrow 65 and the angle indicator 63 where the viewing angle is set to about 90 degree. In this example, the angle is indicated numerically in the scroll arrow 65 and graphic representation of the angle is indicated in the angle indicator 63. The angle indicator 63 changes in the manner similar to the rotation of the polygonal drum to reflect the change of the viewing angle by the scroll arrow 65. Since the viewing angle is set to 90 degrees in FIG. 8A, the navigation system displays the two-dimensional view which is a top view of the buildings B1-B4 as shown in FIG. 8B because it shows the buildings B1-B4 viewed with 90 degree relative to the horizontal surface. Thus, the user can specify an absolute location on the screen by pointing the cursor 62. Further, since POI icons Pi can be displayed on accurate locations on the two-dimensional view, the user can select a correct POI icon such as a one behind the building by operating the cursor 62.

Although the angle is shown in the scroll arrow 65 and the graphic representation shown in the angle indicator 63 in the above-mentioned embodiment, other configuration is also possible to indicate the angle. For instance, the scroll arrow 65 may lack the indication of the angle but the angle indicator 63 may show numeric angle rather than graphic representation of the angle. The numeric angle indication on the scroll arrow may be in the increment of one degree or higher, or numeric indication may be replaced with textual description such as “right top” “lightly angled” and “deeply angled” or any other description.

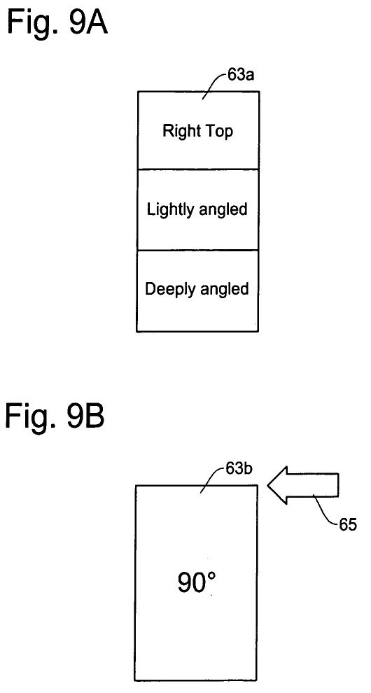

FIG. 9A shows an example where the scroll arrow 65 is eliminated and the angle indicator 63a that is equivalent to the angle indicator 63 in the previous examples has three keys classifying the range of the viewing angle. The user can select either one of the keys for the desired viewing angle of the three-dimensional view by, for example, touching the screen. FIG. 9B shows an example where the scroll arrow 65 does not show numeric indication of the top view angle but instead the angle indicator 63b shows numeric angle rather than the graphic representation shown in FIGS. 6A, 7A and 8A.

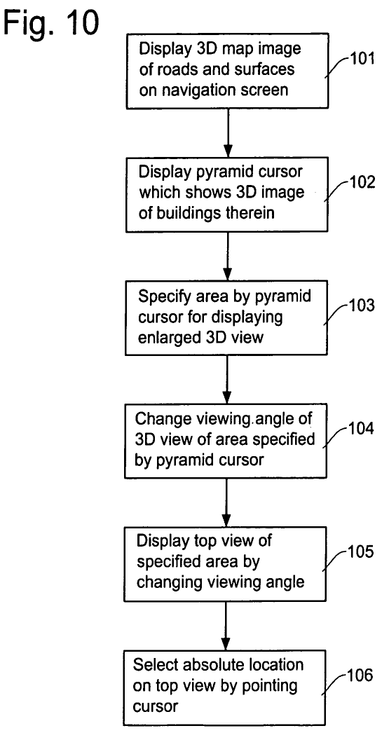

FIG. 10 is a flow chart showing an example of the steps of changing a viewing angle and selecting a location from a three-dimensional view under the present invention. In the first step, the user instructs the navigation system to display a three-dimensional map view in step 101. As noted above, the three-dimensional map view shows the three-dimensional image of the roads and flat surfaces but not the buildings or other structures erected on the surfaces. In step 102, in the three-dimensional map view, the navigation system also displays a pyramid cursor (three-dimensional cursor) 61 automatically or in response to the user's command. The three-dimensional image of the building and other structure within the area of the pyramid cursor 61 will be displayed on the screen.

The user moves the pyramid cursor 61 on the three-dimensional map view and specify an area on the three-dimensional map view by, for example, pressing an enter key. Then, the navigation system displays an enlarged three-dimensional view of the specified area (FIG. 4B) in step 103. The enlarged three-dimensional view includes a three-dimensional image of the buildings and other structures within the specified area.

Alternatively, when the user wants to change the viewing angle of the three-dimensional view, at step 104, the user moves the scroll arrow 65 when the pyramid cursor 61 is displayed on the screen to change the viewing angle. By setting the viewing angle to 90 degrees, the top view of the specified area will be displayed in step 105 as shown in FIGS. 5B and 8B. Thus, in step 106, the user can select an absolute location on the top view for various purposes, such as specifying a destination to reach there through the route guidance, or storing the address in the navigation system, or viewing more details about the location.

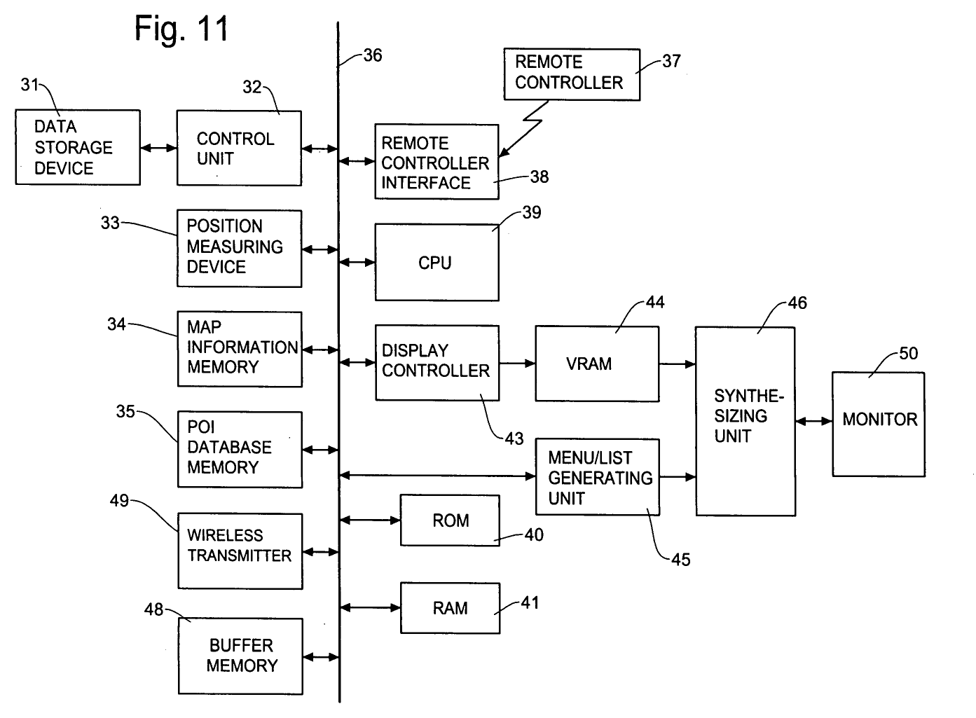

FIG. 11 shows an embodiment of the structure of a vehicle navigation system for implementing the present invention. While the vehicle navigation system is explained for an illustration purpose, the present invention can also be applied to other types of navigation system, such as a portable navigation device implemented by a PDA (personal digital assistant) device, other hand-held devices such as a wireless telephone, or a laptop or notebook computer.

In the block diagram, the navigation system includes a data storage medium 31 such as a hard disc, CD-ROM, DVD or other storage means (hereafter “data disc”) for storing the map data. The navigation system includes a control unit 32 for controlling an operation for reading the information from the data storage medium 31, and a position measuring device 33 for measuring the present vehicle position or user position. For example, the position measuring device 33 has a vehicle speed sensor for detecting a moving distance, a gyroscope for detecting a moving direction, a microprocessor for calculating a position, a GPS (global positioning system) receiver, and etc.

The block diagram of FIG. 11 further includes a map information memory 34 for storing the map information which is read from the Data disc 31, a database memory 35 for storing database information such as point of interest (POI) information which is read out from the data storage medium 31, a remote controller 37 for executing a menu selection operation, an enlarge/reduce operation, a destination input operation, etc. and a remote controller interface 38. Although a remote controller is a typical example for selecting menus, executing selected functions and etc., the navigation system includes various other input methods to achieve the same and similar operations done through the remote controller.

In FIG. 11, the navigation system further includes a bus 36 for interfacing the above units in the system, a processor (CPU) 39 for controlling an overall operation of the navigation system including the three-dimensional display of the present invention, a ROM 40 for storing various control programs such as a route search program and a map matching program necessary for navigation control, a RAM 41 for storing a processing result such as a guide route, a display controller 43 for generating map image (a map guide image and an arrow guide image) on the basis of the map information, a VRAM 44 for storing images generated by the display controller 43, a menu/list generating unit 45 for generating menu image/various list images, a synthesizing unit 46, a wireless transmitter 49 for wireless communication to retrieve data from a remote server, a buffer memory 48 for temporally storing data for ease of data processing, and a monitor (display) 50.

In the configuration described above, a program that performs the steps described with reference to the flow chart in FIG. 10 may be stored in ROM 40. The three-dimensional map image may be generated from the same map data used to generate two-dimensional data, and may be stored in the data storage device 31. Based on the program, the CPU 39 controls the operation of the present invention for displaying the three-dimensional view of the buildings within the area specified by the pyramid cursor, changing the viewing angle of the three-dimensional view, and selecting an absolute location on the two-dimensional view which is attained by changing the viewing angle.

As has been described above, according to the method and apparatus of the present invention, the three-dimensional view of the selected area is rotated about a horizontal axis by changing its viewing angle until it becomes a two-dimensional view which is a top view of the selected area so that the user can select an absolute location on the map image such as a location of the points of interest (POIs) can be displayed. The method uses the three dimensional cursor that covers the specified area on the three-dimensional map image for displaying the detailed three-dimensional view of the specified area. The detailed three-dimensional view of structures such as buildings are displayed only for the specified area. By changing the location of the three-dimensional cursor on the map image, any desired location can be specified by the user. The user can easily change the viewing angle of the three-dimensional view of the specified area and select an absolute location therein when the three-dimensional view is changed to the top view of the specified area.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

What is claimed is:

1. A display method for a navigation system, comprising the following steps of:
displaying a three-dimensional map view on a screen which shows three-dimensional images of roads and ground surfaces but not that of buildings or other structures erected on the surfaces;
moving a three-dimensional cursor on the three-dimensional image for specifying an area for displaying three-dimensional images of buildings and other structures within the specified area;
changing a viewing angle of the three-dimensional images of buildings and other structures within the specified area until the screen shows a top view of the specified area; and
selecting a location on the top view by pointing a cursor thereto.

2. A display method for a navigation system as defined in claim 1, wherein said step of displaying the three-dimensional map view includes a step of displaying the three-dimensional cursor on the three-dimensional map view.

3. A display method for a navigation system as defined in claim 1, wherein said step of displaying the three-dimensional map view includes a step of displaying the three-dimensional cursor for specifying the area on the map view and a scroll key for changing the viewing angle of the three-dimensional view within the specified area.

4. A display method for a navigation system as defined in claim 1, wherein said step of displaying the three-dimensional map view includes a step of displaying the three-dimensional cursor for specifying the area on the map view, a scroll key for changing the viewing angle of the three-dimensional view within the specified area, and an angle indicator which changes in response to movements of the scroll key.

5. A display method for a navigation system as defined in claim 1, wherein said step of changing the viewing angle of the three-dimensional map view includes a step of displaying a two-dimensional view of the specified area which corresponds to said top view of the specified area when the viewing angle is set to one extreme.

6. A display method for a navigation system as defined in claim 1, wherein said step of changing the viewing angle of the three-dimensional map view includes a step of displaying a two-dimensional view of the specified area which corresponds to a front view of the specified area when the viewing angle is set to another extreme.

7. A display method for a navigation system as defined in claim 1, wherein said three-dimensional cursor has a pyramid shape.

8. A display method for a navigation system as defined in claim 4, wherein said scroll key has an arrow shape and shows a numerical value of the viewing angle of the three-dimensional map view.

9. A display method for a navigation system as defined in claim 4, wherein said angle indicator graphically or textually shows the changes of the viewing angle of the three-dimensional map view in response to the movements of the scroll key.

10. A display method for a navigation system as defined in claim 4, wherein said angle indicator is configured by a plurality of angle keys which classify ranges of the viewing angle so that the user can select one of the angle keys.

11. A display apparatus for a navigation system, comprising:
means for displaying a three-dimensional map view on a screen which shows three-dimensional images of roads and ground surfaces but not that of buildings or other structures erected on the surfaces;
means for moving a three-dimensional cursor on the three-dimensional image for specifying an area for displaying three-dimensional images of buildings and other structures within the specified area;
means for changing a viewing angle of the three-dimensional images of buildings and other structures within the specified area until the screen shows a top view of the specified area; and
means for selecting a location on the top view by pointing a cursor thereto.

12. A display apparatus for a navigation system as defined in claim 11, wherein said means for displaying the three-dimensional map view includes means for displaying the three-dimensional cursor on the three-dimensional map view.

13. A display apparatus for a navigation system as defined in claim 11, wherein said means for displaying the three-dimensional map view includes means for displaying the three-dimensional cursor for specifying the area on the map view and a scroll key for changing the viewing angle of the three-dimensional view within the specified area.

14. A display apparatus for a navigation system as defined in claim 11, wherein said means for displaying the three-dimensional map view includes means for displaying the three-dimensional cursor for specifying the area on the map view, a scroll key for changing the viewing angle of the three-dimensional view within the specified area, and an angle indicator which changes in response to movements of the scroll key.

15. A display apparatus for a navigation system as defined in claim 11, wherein said means for changing the viewing angle of the three-dimensional map view includes means for displaying a two-dimensional view of the specified area which corresponds to said top view of the specified area when the viewing angle is set to one extreme.

16. A display apparatus for a navigation system as defined in claim 11, wherein said means for changing the viewing angle of the three-dimensional map view includes means for displaying a two-dimensional view of the specified area which corresponds to a front view of the specified area when the viewing angle is set to another extreme.

17. A display apparatus for a navigation system as defined in claim 11, wherein said three-dimensional cursor has a pyramid shape.

18. A display apparatus for a navigation system as defined in claim 14, wherein said scroll key has an arrow shape and shows a numerical value of the viewing angle of the three-dimensional map view.

19. A display apparatus for a navigation system as defined in claim 14, wherein said angle indicator graphically or textually shows the changes of the viewing angle of the three-dimensional map view in response to the movements of the scroll key.

20. A display apparatus for a navigation system as defined in claim 14, wherein said angle indicator is configured by a plurality of angle keys which classify ranges of the viewing angle so that the user can select one of the angle keys.
